(19) United States
(12) Patent Application Publication
(10) Pub. No.: US 2005/0269297 A1
(43) Pub. Date: Dec. 8, 2005

(54) Resistance weld control with line level compensation

(76) Inventors: Paul Robert Buda, Raleigh, NC (US); Todd Charles Wheaton, Wake Forest, NC (US)

Correspondence Address: Square D Company/Group Schneider;Larry Golden, Esq., Senior Intellectual Property Counsel, 1415 S. Roselle Road, Palatine, IL, 60067-7399, US

(21) Appl. No.: 10/862,117

(22) Filed: Jun. 4, 2004

(51) Int. Cl. B23K 11/24

(52) U.S. Cl. 219/110

(57) ABSTRACT

According to an example embodiment, a system controls a resistance-based welding application with certain compensation for adverse aspects attributable to the power for the welding application being from an AC line. The system includes a power metering arrangement adapted to measure a first value of a power-based parameter from the AC line for a condition in which weld power is not commanded, a second value of the power-based parameter from the AC line while weld power is commanded during a first interval, and a third value of the power-based parameter from the AC line while weld power is commanded during a second interval. The system additionally includes a circuit adapted to respond to the first, second and third values by generating an estimated value for the power-based parameter corresponding to the condition in which weld power is not commanded, wherein the resistance welding application is controlled based on the estimated value.

### FIELD OF THE INVENTION

The present invention is directed to the field of weld controllers and more particularly to a weld controller system which compensates for certain effects of variations in source line levels.

### BACKGROUND

Resistance welding is widely used in applications requiring the joining of materials, such as may be used in the manufacturing of automobiles. Weld controllers have become more sophisticated and often use a variety of circuitry and control techniques to ensure the quality of welds. Regardless of the process or control technique used, a typical weld controller includes a power module, a weld transformer, and contact tips used to present the weld energy. The power module is adapted to control the weld energy using circuitry, such as silicon controlled rectifiers (SCR), which switches incoming energy to the weld transformer. The weld transformer transforms this energy to a high current pulse that is coupled to the contact tips to create a weld in a workpiece that is between the contact tips.

A weld program can use phase angle control to switch the power modules. To maintain the desired level of power delivered to the weld, the proper phase angle to fire the SCRs will be a function of the condition of the power source delivering power to the weld controller and subsequently through the weld controller to the weld transformer.

For example, the available line voltage at the input of the weld controller is a function of the source line voltage and the line impedance. The source line voltage can differ from the nominal line voltage and can vary from cycle to cycle since the voltage source is a real voltage source generated by a power utility and subject to a power distribution system. Additionally, the presence of line impedance causes a voltage drop proportional to the current flowing into the weld controller, and the voltage source has cycle-to-cycle variations. For certain applications and in connection with the present invention, certain benefits can be realized by certain implementations that avoid one or more of these conditions.

These and other considerations have presented challenges to controlling power delivery in welding applications.

### SUMMARY

The present invention is directed to overcoming the above-mentioned challenges and others related to the types of devices and applications discussed above and in other applications. The present invention is exemplified in a number of implementations and applications, some of which are summarized below.

According to an example embodiment of the present invention, a system controls a resistance-based welding application in which a welder is powered from an AC line. The system includes a power metering arrangement adapted to measure a first value of a power-based parameter from the AC line for a condition in which weld power is not commanded, a second value of the power-based parameter from the AC line while weld power is commanded during a first interval, and a third value of the power-based parameter from the AC line while weld power is commanded during a second interval. The system additionally includes a circuit adapted to respond to the first, second and third values by generating an estimated value for the power-based parameter corresponding to the condition in which weld power is not commanded, wherein the resistance welding application is controlled based on the estimated value.

The above summary of the present invention is not intended to describe each illustrated embodiment or every implementation of the present invention. The figures and detailed description that follow more particularly exemplify certain of these embodiments.

### BRIEF DESCRIPTION OF THE DRAWINGS

The invention may be more completely understood in consideration of the detailed description of various embodiments of the invention in connection with the accompanying drawings, in which:

FIG. 1 shows an overview block diagram of a weld controller in accordance with embodiments of present invention;

FIG. 2 is a circuit model representative of a weld controller according to the present invention;

FIG. 3 shows a graphical curve relating weld current to conduction angle for a specific example with a power factor of 30% and a 180 degree conduction current of 4000 Amperes;

FIG. 4 is a waveform diagram illustrating an example of welder loading of the power line illustrating various aspects of the present invention;

FIG. 5 is a waveform diagram illustrating an example of welder loading of the power line for a particular firing angle illustrating various aspects of the present invention; and

FIG. 6 is a detailed block diagram of a weld regulator consistent with that which is shown in FIG. 1.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of power delivery for loads including an inductance, and has been found to be particularly useful for power delivery control in welding applications. For instance, example embodiments of the present invention are applicable for resistance welding applications. While the present invention is not necessarily limited to such applications, various aspects of the invention may be appreciated through a discussion of various examples using this context.

According to an example embodiment of the present invention, a convention power supply line, having varying voltage and/or current levels, is treated to provide an effectively-ideal power source for a weld application. In one particular embodiment and application of the present invention, this treatment provides an ideal voltage source. Measurements of a power line parameter, such as line voltage in this instance, at the input of a weld controller are used to estimate the amplitude of the variable voltage source during a welding operation. The welding operation uses the estimated amplitude of the voltage source to compensate for the variability of the supplied line power.

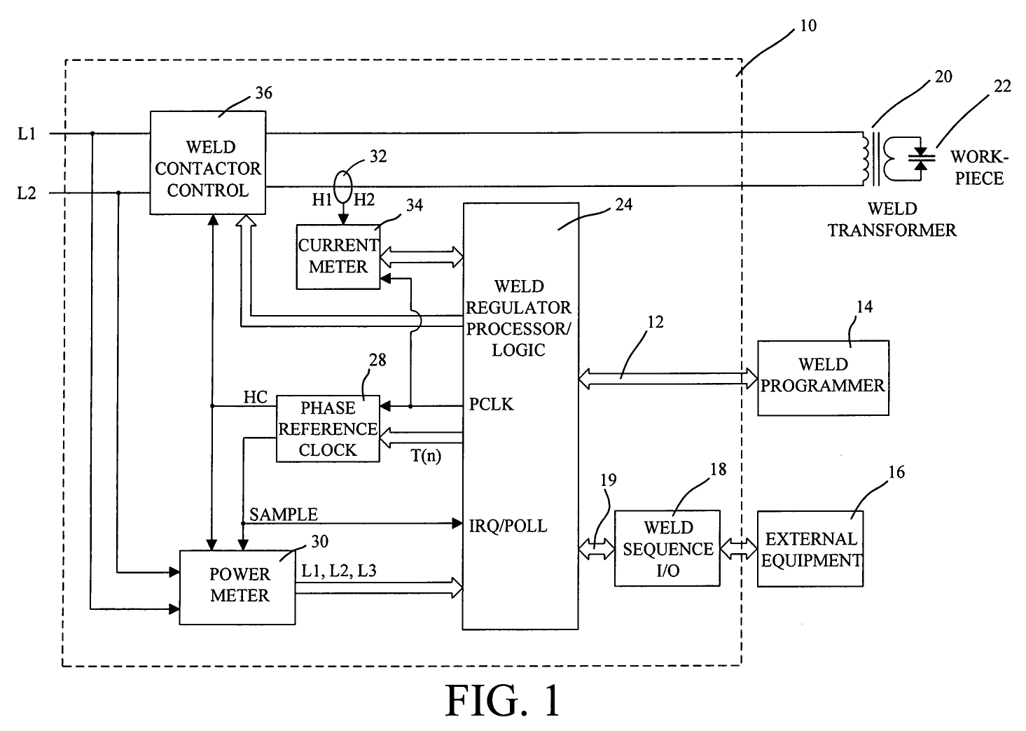

FIG. 1 shows an overview block diagram of a weld controller 10. A source of weld power is connected to the weld controller via the input lines L1 and L2. The weld controller 10 is programmed via a communication link l2 tied to a weld programmer 14, external to the weld controller 10. Once a program is entered via the weld programmer 14, execution of the weld program is initiated via external equipment 16, which is wired to weld sequence I/O 18 which subsequently breaks the weld program down into one or more weld command pulses 19. The output of the weld controller 10 is wired to a weld transformer 20 and gun 22, which passes current through a workpiece comprising two or more pieces of metal that are to be joined.

The weld controller 10 also includes a weld regulator 24 processor or circuit, a weld contactor control 36, and a phase reference clock 28. Power meter 30 is used to measure various parameters of the input line voltage L1-L2, such as volt-time area, and polarity. Power meter 30 provides three supply level measurements L1, L2, and L3 taken at sample times in accordance with various embodiments of the invention. A current sensor 32 generates a current signal H1, H2 proportional to the current flowing in the primary of the weld transformer 20. A current meter 34 is used to measure various parameters of the primary load current, such as ampere-time area, polarity, and conduction time.

The weld regulator 24 consists of a digital signal processor, associated program and data memory, and a time base reference source such as a crystal controlled clock. The weld regulator 24 is the functional brain of the weld controller 10 and interacts with all of the other functions to generate the appropriate timing signals to fire a weld contactor control 36, synchronized with the phase reference clock 28 under software control. The weld contactor control 36 switches line voltage upon command in the form of firing pulses. This contactor 36 generally includes a pair of back to back thyristors with associated snubbing, level shifting, and pulse shaping circuits required to accept the firing pulses. The weld sequence I/O 18 comprises a hardware interface to external equipment 16 which may take the form of hard-wired digital inputs and outputs, or one of several communication interfaces per various commercial standards, and software that upon initiation of a weld program generates one or more weld command pulses 19 to the weld regulator.

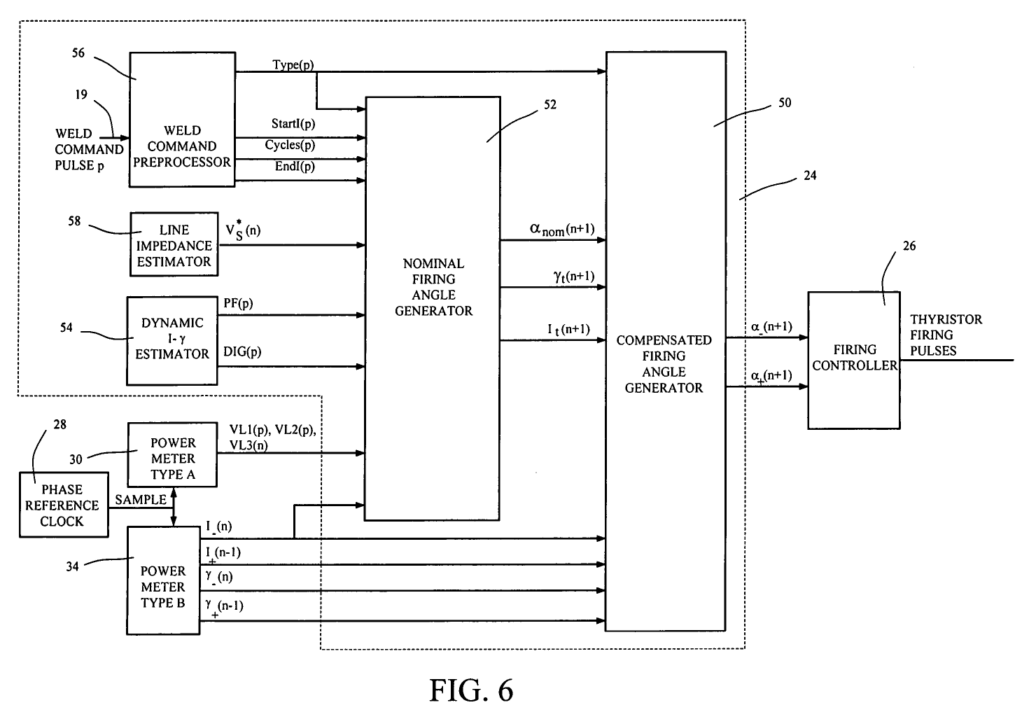

The phase reference clock 28 is a free-running clock which operates independent of software delays. The phase reference clock 28 provides an internal time base for the weld contactor control 36 firing pulses based on an estimate of the frequency and phase of the incoming line voltage L1 and L2. The period of the phase reference clock can be set and modified under software control. In the one embodiment, the phase reference clock is implemented in hardware external to the weld regulator 24 utilizing a commonly available programmable counter. In operation, the counter is programmed to generate a square wave which may generate an interrupt sequence used by the weld regulator 24. In another embodiment, the weld regulator 24 may poll the sample output from the phase reference clock 28. Each interrupt may cause the weld regular 24 to sample the output of the power meter 30 and the current meter 34. The period of the counter is programmed by the weld regulator 24, which sets the period of the clock to track a fixed number of samples in the period of the input line voltage. The phase reference clock may have a high control bandwidth while power is not being delivered to the welding load and a low control bandwidth while power is being delivered to the welding load, such that the phase reference clock nominally tracks the source phase during a welding operation. Details of various blocks shown in FIG. 1 (as well as FIG. 6) may be better understood with reference to commonly assigned U.S. patent documents U.S. Pat. No. 5,869,800, entitled “Phase Distortion Compensated Time Base for a Weld Controller”, and U.S. Pat. No. 6,013,892, entitled “Resistance Weld Control with Line Impedance Compensation”, which are incorporated herein by reference.

The weld controller 10 supports two weld control types: A Percent Current (% I) weld which adjusts thyristor firing angles to regulate a voltage and line impedance compensated conduction angle representing a percentage of maximum weld current with an assumed line and load impedance at the nominal line voltage, and a Constant Current weld which adjusts the thyristor firing angles to achieve a target current directly. The general form of % I Weld commands indicate a percentage of the maximum controllable current as determined from an estimated relation between the solid state contactor conduction angle and expected weld current as stored in an I-γ table. The term maximum controllable current will be defined subsequently. The first form of the % I command is intended to deliver a constant weld pulse of XX cycles at YY percent of maximum controllable current. The second form is intended to ramp the weld current from Y1 to Y2 percent of maximum controllable current linearly over XX cycles of weld.

The general forms of Constant Current weld commands in the weld controller 10 include a first form that attempts to deliver a weld current of YY Amperes RMS to the primary of the weld transformer over a period of XX cycles. A second form allows a user to program a desired secondary current, which the weld controller 10 subsequently converts to primary amperes from knowledge of the weld transformer turns ratio. Similarly, a third form of the weld command attempts to create a linear ramp of weld current from Y1 Amperes to Y2 Amperes over a period of XX cycles, and a forth command allows the user to specify the weld current targets for the linear ramp in secondary kilo-Amperes, which are subsequently converted by the weld controller 10 to primary amperes.

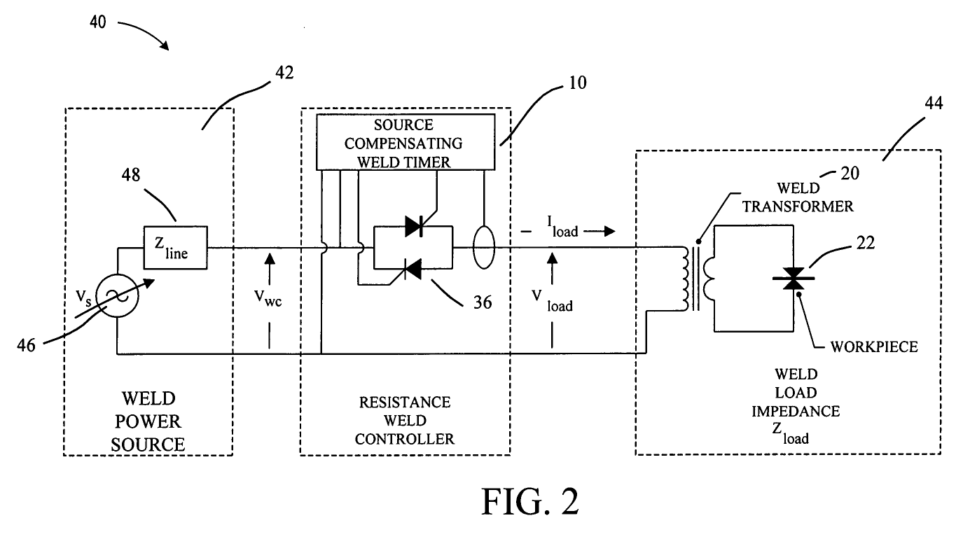

FIG. 2 is a circuit model 40 representative of a weld controller 10, and associated power distribution system 42 and weld load 44 which will be used to derive mathematics of the weld controller 10. The model 40 comprises a weld power source 42, the weld controller 10, and a weld load impedance 44. The weld power source 42 is modeled as two circuit elements, a voltage source 46, which is assumed to be an ideal, but variable, voltage source having no series impedance and a serially connected line impedance 48, Z_{LINE}, which is assumed to be ideal and linear and which generates a voltage drop between the ideal voltage source and the weld control proportional to the weld load current. The weld controller 10 is capable of observing the load current I_{LOAD} and the voltage applied at its input terminals, V_{WC}. Using thyristor-based phase control, the weld controller generates a weld voltage V_{LOAD} at its output terminals, with a corresponding weld current load. The weld load impedance 44 includes the weld based transformer 20, tooling 22, workpiece and fixtures and other sources of impedance. To facilitate discussion of the mathematics, the impedance of all these elements are lumped into a single impedance quantity reflected at the output terminals of the weld controller 10 as Z_{LOAD}. When the weld controller 10 applies the voltage V_{LOAD} upon the load impedance 44, the resulting current is I_{LOAD}.

To maintain independence of frequency in the discussion that follows, the sinusoidal voltage source can be scaled in degrees instead of time. With the sinusoid defined in degrees, the thyristor is fired at an angle a with respect to the phase reference clock which nominally tracks the zero crossings of the sinusoidal voltage source, at which time the thyristor begins to conduct current. The relationship between the line voltage and line current while conducting is proportional to:

$$i ( θ ) = \{ \begin{matrix}0 & 0 < ϕ < α \\ sin ( ϕ - θ ) - {ⅇ}^{- ( \frac{ϕ - α}{tan θ} )} sin ( α - θ ) & α \leq ϕ \leq α + γ \\ 0 & ϕ > α + γ\end{matrix} \qquad ( 1 )$$

where φ is the angle of observation, α is the angle with respect to the zero crossing of the line voltage at which the thyristor is fired, θ is the lag angle of the load, and γ is the conduction angle of the thyristor, the smallest angle for which:

$$sin ( α + γ - θ ) - {ⅇ}^{- \frac{γ}{tan θ}} sin ( α - θ ) = 0 , γ > 0 \qquad ( 2 )$$

is satisfied. The lag angle of the load impedance, θ in Equation (1), is related to the circuit power factor, pf, by:
θ=arccos(pf) (3)
Assuming the parameter model 40 of FIG. 2, for a normalized ideal source of weld voltage 46 and a normalized combination of the line impedance 48 and welding load impedance 44 that is inductive in nature, the RMS current that results from a half-cycle of conduction of the thyristor as a function of the weld conduction angle and the power factor may be shown graphically. In the parameter model 40, the total load may be completely characterized by an I-γ curve. To do so, it is sufficient to have knowledge of the circuit power factor, which uniquely dictates the “shape” of the total load impedance characteristic and the weld current at one conduction angle and at a known ideal supply voltage. The maximum current that can be generated at full 180 degree conduction and at nominal ideal supply voltage, V_{S}=V_{NOM}, is henceforth referred to as I₁₈₀ and is given by:

$${I}_{180} = \frac{{V}_{NOM}}{{Z}_{LINE} + {Z}_{LOAD}} \qquad ( 4 )$$

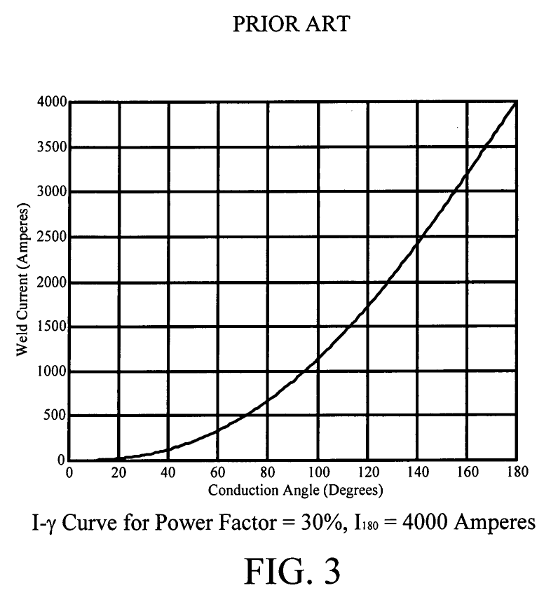

Given the value of I₁₈₀ and the normalized I-γ curve for the power factor of the combination of the line impedance and the load impedance, the curve relating the actual weld current to the conduction angle at the nominal supply voltage may be constructed. FIG. 3 shows such a graphical curve relating weld current to conduction angle for a specific example with a power factor of 30% and a maximum current, I₁₈₀, of 4000 Amperes. Given FIG. 3 for an expected power factor, and a desired weld current, the conduction angle required to achieve the desired current can be determined from the graph. Equations (2) and (3) above relate the firing angle, conduction angle, and load power factor. As such, a table-lookup scheme with linear interpolation in the expected power factor and conduction angle directions may be employed to determine the firing angle. Furthermore, the actual conduction angle may be measured after each firing and a table-lookup scheme with linear interpolation in both the firing angle and conduction angle directions may be employed to determine the actual circuit power factor. The updated power factor is used to generate a Dynamic I-γ curve (DIG) model, maintained within the weld controller 10, which provides a relationship between the conduction angle and expected resulting weld current. This information and a scaling term of V_{S}/V_{NOM} may be used as the basis for computing a feedforward term in a weld controller weld regulator control strategy.

In certain embodiments of the present invention, the maximum controllable weld current, I_{MAX}, is defined as that current given by the Dynamic I-γ curve at 170 degrees conduction angle, allowing for a 10 degree correction in conduction angle target to compensate for the effects of line voltage variation and line impedance at the highest % I values. When a % I weld is programmed, the target current is the percentage of I_{MAX} indicated. Similarly, the % I corresponding to a target current in a constant current weld is determined by dividing the target current by I_{MAX}.

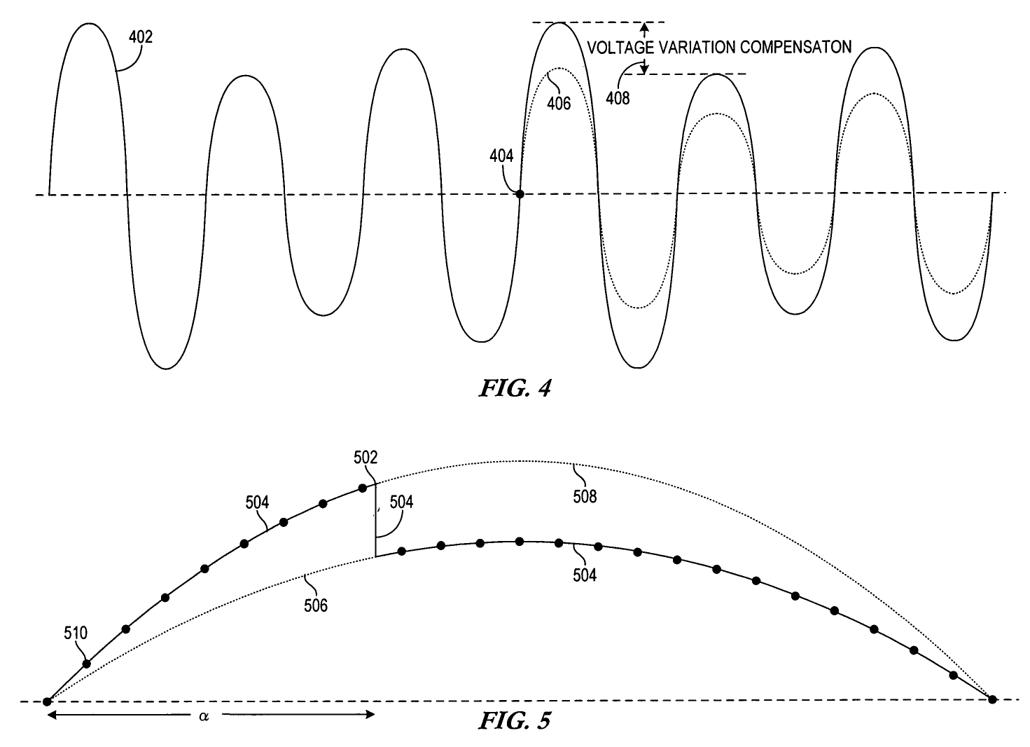

FIG. 4 is a waveform diagram illustrating an example of welder loading of the power line. Solid line 402 is a power parameter for the unloaded power line. In one embodiment, solid line 402 may represent the line voltage measured when the welder is not supplying power to the welding load. Due to power line variations, the amplitude of the supplied power parameter may vary, and embodiments of the invention compensate 408 for variations in the supplied power level.

At point 404 the welder may begin supplying power to the welding load. Dotted line 406 is the loaded value of the power parameter, such as line voltage, observed at the power line input to the welder system for an example welder system that continuously applies power to a resistive welding load with a conduction angle of 180 degrees.

The drop between 402 and 406 may be caused by a drop across the line impedance. The line impedance and the load impedance may form a voltage divider, such that V_{WC}=V_{S}(Z_{LOAD}/(Z_{LINE}+Z_{LOAD})). The load impedance may depend on the loop inductance of the wiring between the weld transformer and the gun tooling, but may be relatively constant during a particular welding operation. A surprising discovery is that the line impedance is nearly constant for a particular welding system. The line impedance for a particular welding system varies when modifications are made to the distribution system, such as when a factory floor is reconfigured. Typically, the line impedance for a welding system is constant for an interval of a number of months.

In contrast, the line voltage 402 may vary from cycle to cycle. For a typical welding operation of 3-6 cycles, the variation of the of the line voltage 402 may adversely affect the welding operation unless voltage compensation is used.

Because the line impedance and load impedance are substantially constant for a particular welding operation, an estimate for the magnitude of the V_{S}/V_{WC} ratio, hereafter referred to as V_{S}/V_{WC} ratio, may be used during the welding operation to estimate V_{S} from a measured V_{WC}. In one embodiment, measurements of V_{WC} in one or more half cycles before power is delivered to the welding load at point 404 are used to approximate V_{S} in the first cycle or half-cycle of power delivery after point 404 where the loaded V_{WC} is measured to generate the estimate for the V_{S}/V_{WC} ratio. A relative average, such as an exponentially weighted moving average, over several half cycles prior to point 404 may be used to approximate V_{S} in the first cycle or half-cycle of power delivery after point 404. In another embodiment, V_{S} in the first cycle or half-cycle of power delivery after point 404 may be approximated by a single measurement of V_{WC}, such as the cycle or half-cycle immediately prior to point 404.

FIG. 5 is a waveform diagram illustrating an example of welder loading of the power line for a particular firing angle. A firing angle 502, α, of approximately 62 degrees in a half cycle is shown. In general, the firing angle is not 180 degrees as was illustrated in FIG. 4. Prior to the firing angle 502, the voltage waveform of solid line 504 V_{WC} may follow the ideal line voltage, and after the firing angle 502, the waveform of solid line 504 may follow the loaded line voltage. Dotted line 506 illustrates the extrapolation of the loaded line voltage to the beginning of the half cycle, and dotted line 508 illustrates the extrapolation of the loaded line voltage to the end of the half cycle.

The waveform of solid line 504 may have sampled voltage measurements illustrated by dots 510, with the sampling rate determined by a phase reference clock. In one embodiment, 64 samples are taken every half cycle. The samples of dots 510 taken after the firing angle 502 may be extrapolated to determine a root mean square (RMS) value for V_{WC} in the half cycle. In one embodiment, the samples of dots 510 take before the firing angle 502 may be extrapolated to determine V_{S} in the first or subsequent half cycle of power delivery to the welding load when there are sufficient samples before the first firing angle to make an accurate estimate. The extrapolated V_{WC} in the half cycle and either the extrapolated V_{S} for the first half cycle of power delivery or an estimated V_{S} from one or more half cycles before beginning power delivery may be used to estimate the V_{S}/V_{WC} ratio. In cycles subsequent to the first half cycle, the estimate of the V_{S}/V_{WC} ratio may be used to determine an estimate for V_{S} in the half cycle from the extrapolated V_{WC} in the half cycle.

In one embodiment, an extrapolated value for V_{WC} in a half cycle is determined by first integrating the volt-time area for the samples after the firing angle 502. The integration may use a Newton-Cotes formula such as a trapezoidal approximation, or a Simpson's rule including the ⅜ Simpson's rule. The volt-time area is extrapolated to an entire half cycle based on the number of samples and converted to an RMS value. A similar integration, extrapolation, and conversion may be used for the samples before the firing angle 502 to estimate V_{S} in the half cycle.

A table of conversion factors may be used to extrapolate the volt-time area between the firing angle and the end of the half cycle to an RMS voltage value. Each table entry may contain a factor based on the ratio of the area under a half cycle of a unity amplitude sine function, and the area from an integration of the sine function between the firing angle (or the angle of the first sample after the firing angle) and 180 degrees. Each table entry may contain an additional factor to convert volt-time area to an RMS voltage.

For discussion clarity, FIGS. 4 and 5 illustrate waveforms for a resistive load, while the actual load is inductive in nature. The lag of the current through the inductive load may cause the voltage waveform V_{WC} to lead V_{S}. The phase reference clock is nominally locked to V_{S}, such that the end of a half cycle of V_{S} may be determined. Near the end of the half cycle of V_{S}, the leading V_{WC} waveform may switch polarity by crossing through 0 volts. In one embodiment, the volt-time area calculated between the firing angle and the end of the half cycle is an integral through 180 degrees and includes any negative area at the end of the half cycle. In another embodiment, the volt-time area calculated between the firing angle and the end of the half cycle does not include the negative area.

The RMS I_{LOAD} current may similarly be determined by sampling the output of the current meter at sample times given by the sample output of the phase reference clock, integrating the samples to calculate ampere-time area, and converting the ampere-time area to an RMS current value at the nominal or measured line frequency.

FIG. 6 shows a detailed block diagram of the weld regulator 24 consistent with that which is shown in FIG. 1. It is the central element of the weld controller 10 and interacts with all of the other functions to determine and generate the appropriate timing signals to fire the thyristors through the firing controller module 26. Its function is to develop a nominal firing angle sequence that would develop a correct weld sequence, at the nominal line voltage and assuming that the combination of the load impedance and line impedance may be estimated exactly, and then make minor adjustments to the nominal sequence based on the actual observed behavior of the system while in operation. The two main blocks of the weld regulator 24 are a compensated firing angle generator 50 which modifies the nominal sequence, and a nominal firing angle generator 52.

To generate the nominal firing angle and target conduction angle and current sequences, the nominal firing angle generator 52 needs several inputs. First, a weld command preprocessor function 56 derives information from the pth weld pulse command as programmed by an operator, including a starting target value, StartI(p), of primary current for this pth pulse, an ending target value, EndI(p), of primary current for this pth pulse, the number of cycles Cycles(p) of weld in the pth pulse, and the weld type (% I or CCWELD), labeled Type(p).

In the case of a Constant Current weld, preprocessing involves converting any secondary current values entered into primary currents (using the specified transformer turns ratio) and extracting the information above. In the case of a % I weld, the programmed percentages are converted into target primary currents by multiplying the user programmed percentage by I_{MAX}, the current from the DIG that would be supplied by the weld control into the nominal estimated combination of line and load impedances at nominal designed voltage at a conduction angle of 170 degrees as described above. StartI(p), EndI(p), Cycles(p), and Type(p) are all inputs to the nominal firing angle generator 52, and Type(p) is also an input to the compensated firing angle generator.

A line voltage estimator function 58 provides an estimate of the open circuit line voltage V_{S}*(n) for half cycle n to the nominal firing angle generator 52. A dynamic I-γ estimator function 54 maintains an estimate of the load power factor, PF(p), and a table of estimated I-γ values, DIG(p), both derived from previous welds. The line voltage estimate V_{S}*(n) is used to scale the DIG(p) values from the nominal line voltage to the estimated line voltage. Samples of the output of the power meter type A function 30 are used to generate an estimates, such a voltage measurements V_{L1}(p), V_{L2}(p), and V_{L3}(n) of the RMS line voltage furnished to the nominal firing angle generator 52. Each pulse may have an initial estimate of the unloaded open circuit voltage at the beginning of the pulse, V_{L1}(p), a loaded voltage obtained during the first cycle of the pulse, V_{L2}(p), and a loaded voltage obtained during each subsequent cycle of the pulse, V_{L3}(n). Samples of the power meter type B 34, such as a current meter, are used to generate an estimated sequence I₋ (n) of the RMS current for each negative half cycle, furnished to both the nominal firing angle generator 52 and compensated firing angle generator 50, as well as furnishing the sequence of estimated positive half-cycle current, I₊ (n−1), the negative conduction angle sequence, γ₋ (n), and positive conduction angle sequence γ₊ (n−1) to the compensated firing angle generator 50. Samples for power meters 30 and 34 are taken under control of the phase reference clock 28.

With the inputs as given above, the nominal firing angle generator 52 provides a sequence of nominal firing angles, α_{NOM}(n+1), a compensated target conduction angle sequence, γₜ(n+1), and a target current sequence, Iₜ (n+1), to the compensated firing angle generator 50. The compensated firing angle generator 50 provides a sequence of positive half-cycle firing angles α₊ (n+1), and a sequence of negative half-cycle firing angle values γ₋(n+1) to the firing controller 26, which outputs of the sequence of electrical impulses that trigger the thyristor, causing weld current to flow.

In addition, a variety of other power delivery applications for inductive loads can be performed using the approaches discussed herein.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For example, while some of the various detailed embodiments have been described as compensating for variations in the voltage level, the decoupling of the source line variations provided in connection with embodiments herein can also be provided by measuring and treating another power parameter such as current, or multiple power parameters. Such modifications do not depart from the true spirit and scope of the present invention that is set forth in the following claims.

1. A system for controlling a resistance-based welding application in which a welder is powered from an AC line, comprising:
power metering arrangement adapted to measure
a first value of a power-based parameter from the AC line for a condition in which weld power is not commanded,
a second value of the power-based parameter from the AC line while weld power is commanded during a first interval, and
a third value of the power-based parameter from the AC line while weld power is commanded during a second interval; and
a circuit adapted to respond to the first, second and third values by generating an estimated value for the power-based parameter corresponding to the condition in which weld power is not commanded, wherein the resistance welding application is controlled based on the estimated value.

2. The system of claim 1 wherein the power meter is a voltmeter.

3. The system of claim 1 wherein the circuit includes a programmable integrated circuit.

4. The system of claim 1 wherein the power-based parameter is selected from the following set of parameter types: voltage, current, and loaded line impedance.

5. The system of claim 1 wherein generating an estimated value for the power-based parameter comprises multiplying the third value by the ratio of the first value to the second value.

6. A system for controlling a resistance-based welding application in which a welder is powered from an AC line, comprising:
means for measuring a first value of a power-based parameter from the AC line for a condition in which weld power is not commanded;
means for measuring a second value of the power-based parameter from the AC line while weld power is commanded during a first interval;
means for measuring a third value of the power-based parameter from the AC line while weld power is commanded during a second interval;
means, as a function of the first value, the second value and the third value, for generating an estimated value for the power-based parameter corresponding to the condition in which weld power is not commanded, wherein the resistance welding application is controlled based on the estimated value.

7. A method of controlling a resistance-based welding application in which a welder is powered from an AC line, comprising:
measuring a first value of a power-based parameter from the AC line for a condition in which weld power is not commanded;
measuring a second value of the power-based parameter from the AC line while weld power is commanded during a first interval;
measuring a third value of the power-based parameter from the AC line while weld power is commanded during a second interval;
as a function of the first value, the second value and the third value, generating an estimated value for the power-based parameter corresponding to the condition in which weld power is not commanded, wherein the resistance welding application is controlled based on the estimated value.

8. The method of claim 7 wherein measuring the first value, measuring the second value, and measuring the third value further comprises measuring each value by a respective scaling of a respective integration over a respective portion of a corresponding half-cycle of the line voltage.

9. The method of claim 8 wherein each respective integration uses a Newton-Cotes formula for a plurality of samples of each respective portion of each corresponding half-cycle of the line voltage.

10. The method of claim 9 wherein the Newton-Cotes formula is one of a trapezoidal rule, a Simpson's rule, and a Simpson's ⅜ rule.

11. The method of claim 7 wherein measuring the first value further comprises:
calculating a plurality of integrations of the line voltage over a corresponding plurality of half-cycles of the line voltage prior to the half-cycle in which weld power is commanded;
calculating an exponentially weighted moving average of the plurality of integrations; and
scaling the average by a factor that converts a half-cycle of volt-time-area to root-mean-square voltage.

12. The method of claim 8 wherein measuring the first value further comprises:
integrating over the corresponding half-cycle of the line voltage; and
scaling by a factor that converts a half-cycle of volt-time-area to root-mean-square voltage.

13. The method of claim 12 wherein integrating over the corresponding half-cycle of the line voltage further comprises integrating over a half-cycle of line voltage prior to a half-cycle in which weld current is commanded.

14. The method of claim 9 wherein measuring the first value further comprises measuring the line voltage in a half-cycle immediately prior to a half-cycle in which weld current is commanded.

15. The method of claim 7 wherein the third value is multiplied by the ratio of the first value to the second value, thereby generating the estimated value for the power-based parameter
